(19) United States
(12) Patent Application Publication
(10) Pub. No.: US 2009/0308885 A1
(43) Pub. Date: Dec. 17, 2009

(54) Modular gravity feed storage and dispensing assembly

(76) Inventors: Anthony V. Sainato, Pittsburgh, PA (US); Jeffrey H. Natcher, Tallmadge, OH (US)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 12/157,687

(22) Filed: Jun. 12, 2008

(51) Int. Cl. G07F 11/00

(52) U.S. Cl. 221/194

(57) ABSTRACT

A modular gravity feed storage and dispensing assembly including a dispenser having a plurality of spaced vertically disposed panels with a ramp assembly disposed between adjacent vertically disposed panels whereby a chute is provided between each of the adjacent panels for defining a travel path to guide articles traveling therealong between adjacent panels. The ramp assembly is slightly inclined so as to allow cylindrical articles to be rollingly advanced by means of gravity from an upper portion between the panels in the chute to a lower portion, and a removal area is disposed proximate the lower portion of the chute for allowing selective removal of one or more of the articles from the dispenser. A parallel pair of spaced and horizontally disposed elongated shelf bars are supported on opposite ends and provide front and rear dispenser support bars, and corresponding spaced front and rear support saddles depend downwardly from the dispenser and are positioned to respectively register over and engage the front and rear support bars instead of supporting the dispensers on a conventional shelf. Each ramp assembly includes a central raised ramp surface running with the chute for engagement with a rolling article to be dispensed, and side relief channels are provided on opposite sides of the ramp surface to receive annularly protruding end rims of an article, such as a can, rolling down the ramp surface whereby side surfaces of the article will remain in rolling contact with the ramp surface. Each vertically disposed panel of the dispenser is unitarily molded as a subassembly with a horizontally extending ledge which provides the entire ramp assembly.

### BACKGROUND OF THE INVENTION

The present invention relates generally to a storage and dispensing assembly, and more particularly, a modular storage and dispensing assembly for dispensing rolling articles by gravity feed, such as cans and bottles.

Gravity feed dispensers have been used in the product dispensing markets, ie., grocery stores, supermarkets, convenience marts and department stores, to provide on-shelf storage, automatic rotation of stock, and easy access for customers. The products are arranged on a rack which is inclined to horizontal such that when a customer removes one product at an end of a row of products, the entire row of products indexes forward one location equivalent to one product. The modular storage and dispensing assemblies of the prior art include a plurality of panels and connecting assembly for connecting adjacently disposed panels such that a chute is formed between each of the adjacently disposed upright panels. A rail or ramp assembly is provided in each chute for defining a travel path through the chute. The rail or ramp assembly is sloped in a downward direction whereby the produce cans or bottles roll down the chutes. A removal area is disposed at the lower portion of the chute which allows for selective removal of one or more articles, which are sequentially replaced by gravity feed.

Examples of such prior art assemblies are illustrated in U.S. Pat. Nos. 5,462,198; 6,991,116 and 7,207,447.

Problems encountered with prior art modular display racks or assemblies are that such assemblies are overly limited in storage capacity, conform to conventional shelving systems when in fact there are better alternatives, are difficult to relocate from one shelf section to another when it is desired to move the produce, they are too expensive to manufacture and difficult to assemble, and the articles do not always freely flow down the chutes. When store resets are required with some of the prior art systems, the product must be emptied from the assemblies before moving them and the assemblies must be disassembled and are difficult to reassemble.

### SUMMARY OF THE INVENTION

The present invention provides a modular gravity feed storage and dispensing assembly for storing, displaying and dispensing cans and bottles or other rolling articles. The dispenser includes a plurality of spaced vertically disposed panels with a ramp assembly disposed between adjacent vertically disposed panels whereby a chute is provided between each of the adjacently vertically disposed panels for defining a travel path to guide articles traveling therealong between adjacent panels. The ramp assembly is slightly inclined so as to allow cylindrical articles to be rollingly advanced by means of gravity from an upper portion between the panels in the chute to a lower portion between the panels in the chute. A removal area is disposed approximate the lower portion of the chute for allowing selective removal of one or more of the articles from the dispenser.

In one embodiment of the present invention a parallel pair of spaced and horizontally disposed elongated shelf bars, supported on opposite ends, are provided as front and rear dispenser support bars. Spaced front and rear support saddles depend downwardly from the dispenser and are positioned to respectively register over the front and rear support bars, with a front portion of the dispenser containing the removal area overhanging the front dispenser support bar. The rear support saddles have a rearward facing C-shaped configuration dimensioned and contoured to slide rearwardly over the rear support bar, and the front support saddles have a downwardly facing C-shaped configuration dimensioned and contoured to slide downwardly over the front support bar after the rear support saddle has been slid into position over the rear support bar, whereby the dispenser is thereby prevented from sliding or tipping over in the forward direction.

The rear support bar may be positioned higher than the front support bar in order to more favorably present the articles to be dispensed, to create maximum storage space within the dispenser, and to provide more incline for better stock feed. The front support saddle or saddles may be provided with opposed inwardly extending protrusions on distal ends of the front saddle which are positioned and dimensioned to protrude slightly under the front support bar for thereby serving as a removal resistant detention of the front saddle from the front bar. This serves as a safety feature to resist accidental dislodgement of the dispensers from the support bars.

A second embodiment of the present invention provides the ramp assembly with a central raised ramp surface running with the chute for engagement with a rolling article to be dispensed, and side relief channels on opposite sides of the ramp surface to receive annularly protruding end rims of an article rolling down the ramp surface whereby the article will always be in rolling contact with the ramp surface. For example, when dispensing cans of typical construction which include top and bottom rolled end rims that extend further in diameter than the side of the can, the can will freely roll on its side down the ramp surface as the end rims cannot interfere as they are provided with relief by permitting them to protrude into the side relief channels on opposite sides of the ramp surface.

In a third embodiment of the present invention, a first one of the vertically disposed panels is provided with an integrally formed ledge horizontally protruding in one direction from the vertically disposed panel for thereby providing the ramp assembly. These unitarily molded assembly section or subassembly may be produced in mass and the assemblies may be stacked together side by side and secured to each other by appropriate means, such as screws or snap connections, to provide a completed dispenser with multiple chutes. A single such subassembly may be closed off with a second vertically disposed panel secured to the distal edges of the ledge to provide a completed dispenser with a single chute, or another duplicate subassembly may be secured to the distal edges of the ledge of the first one of the vertically disposed panels to provide a completed dispenser with two of said chutes. This assembly may then be closed off with a single final vertically disposed panel or multiple chutes may be added by adding on additional subassemblies.

An additional feature to this embodiment may be provided in the form of including a secondary ramp assembly which is also slightly inclined to receive rolling stock at an upper end thereof. This secondary ramp assembly is positioned under the upper portion of the chute but above the lower portion for storing extra articles thereon in otherwise unused space between the upper and lower portions of the chute. This permits the storage of additional stock in a space which is otherwise normally left vacant. A hinged access door is provided to cover the stock access area and also the upper end of the secondary ramp assembly. This hinged door is provided with removable exterior advertising display indicia on the door for indicating and advertising the article contained in the chute. As with the prior art assemblies, a hinged access door will normally also be provided to cover the stock access area of the dispenser of the present invention, and provided with removable exterior advertising display indicia on the door for indicating the article contained in the chute. If desired, this hinged access door may be provided with different or unusual contours to assist in distinguishing one product or article contained therein from another dispenser containing a different article.

### BRIEF DESCRIPTION OF THE DRAWINGS

Other objects and advantages appear hereinafter in the following description and claims. The accompanying drawings show, for the purpose of exemplification, without limiting the scope of the present invention or appended claims, certain practical embodiments of the present invention wherein:

FIG. 1 is a perspective view of a modular storage and dispensing assembly constructed in accordance with the teachings of the present invention, the modular storage and dispensing assembly being shown with three chutes, without the inclusion of the cans to be contained and dispensed therein;

FIG. 2 is a view of the modular storage and dispensing assembly of FIG. 1 shown in reverse perspective with the vertically disposed end cover panel removed to disclose the interior thereof;

FIG. 3 is a perspective view of the modular storage and dispensing assembly constructed in accordance with the teachings of the present invention, the modular storage and dispensing assembly being shown with two chutes, each of which contain a plurality of cans;

FIG. 4 is a perspective view of the modular storage and dispensing assembly of the type illustrated in FIG. 1 with three chutes, each of which contain a plurality of cans in the removal area of the assembly and with the assembly supported on the spaced front and rear shelf bar support system of the present invention;

FIG. 5 is a perspective view of multiple modular storage dispensing assemblies of the type shown in FIG. 3 as stored side by side on the front and rear bar support system shown in FIG. 4 to make up a completed display shelf in accordance with the teachings of the present invention; and

FIG. 6 is a perspective view of a modular storage and dispensing assembly constructed in accordance with the teachings of the present invention, the modular storage and dispensing assembly being shown with one chute and with the end cover panel removed to disclose the interior, including a secondary ramp assembly for storing additional articles than those already stored in the single chute.

### DETAILED DESCRIPTION OF THE PREFERRED EMBODIMENTS

Referring to the drawings, the gravity feed storage and dispensing assembly of the present invention includes a dispenser 10 which is comprised of a plurality of spaced vertically disposed panels 11 with a ramp assembly 12 disposed between adjacent vertically disposed panels 11 whereby a chute 13 is provided between each of the adjacent vertically disposed panels 11 for defining a travel path to guide articles 14 traveling along between adjacent panels 11. The ramp assembly 12 is slightly inclined so it will allow cylindrical articles 14 to be rollingly advanced by means of gravity from an upper portion 15 between panels 11 in said chutes 13 to a lower portion 16 between said panels 11 in said chutes 13.

A removal area 17 disposed approximate the lower portion 16 of chutes 13 is provided for allowing selective removal of one or more of the articles 14 from dispenser 10.

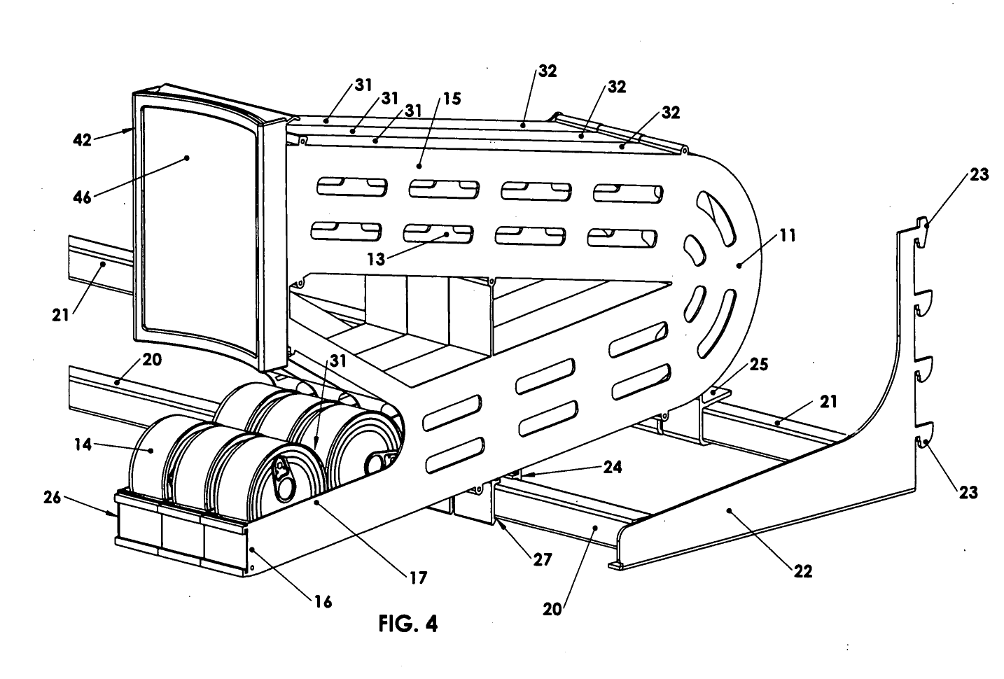

As best illustrated in FIG. 4, a parallel pair of spaced horizontally disposed elongated shelf bars 20 and 21 are supported on opposite ends by shelf brackets 22, thereby providing front and rear dispenser shelf support bars 20 and 21 respectively. Support brackets 22 in turn are provided with convention finger cams 22 for supporting the entire shelf system on a conventional shelf vertical support (not shown).

Spaced front and rear support saddles 24 and 25 respectively depend downwardly from each dispenser 10 and are positioned to respectively register over the front and rear support bars 20 and 21 respectively, with a front portion 26 of dispenser 10 containing the removal area 17 overhanging front dispenser support bar 20. This permits the storage of extra articles 14 due to the overhang or cantilever capabilities of the dispenser 10 on support bars 20 and 21. This cantilever support system is permitted due to the fact that the rear support saddles 25 have a rearward facing C-shaped configuration dimensioned and contoured to slide rearwardly over rear support bar 21, and front support saddles 24 have a downwardly facing C-shaped configuration dimensioned and contoured to slide downwardly over the front support bar 20 after the rear support saddle 25 has been slid in position over rear support bar 21, whereby the dispenser 10 is thereby prevented from sliding or tipping over in the forward direction. In the configuration illustrated in FIG. 4, the rear support bar 21 is positioned higher than the front support bar 20. This provides additional advantages of permitting more storage capabilities for the articles 14, a fuller display and additional incline for the ramp assembly 12, thereby insuring continued rolling of the articles 14 in their respective chutes 13.

For additional safety in securement of the system on support bars 20 and 21, front support saddles 24 are provided with opposed inwardly extending protrusions 27 on the distal end of the front saddles 24 to protrude slightly under front support bar 20 for thereby serving as a removal resistance retention of front saddles 24 from front support bar 20.

A second embodiment of the present invention is provided in the ramp assembly 12 which is provided with a central raised ramp surface 28 running with each chute 13 for engagement with a rolling article 14 to be dispensed. Side relief channels 30 are provided on opposite sides of ramp surface 28 to receive annularly protruding end rims 31 of each article 14 rolling down the ramp surface 28 whereby the article 14 will always be in rolling contact with the ramp surface 28.

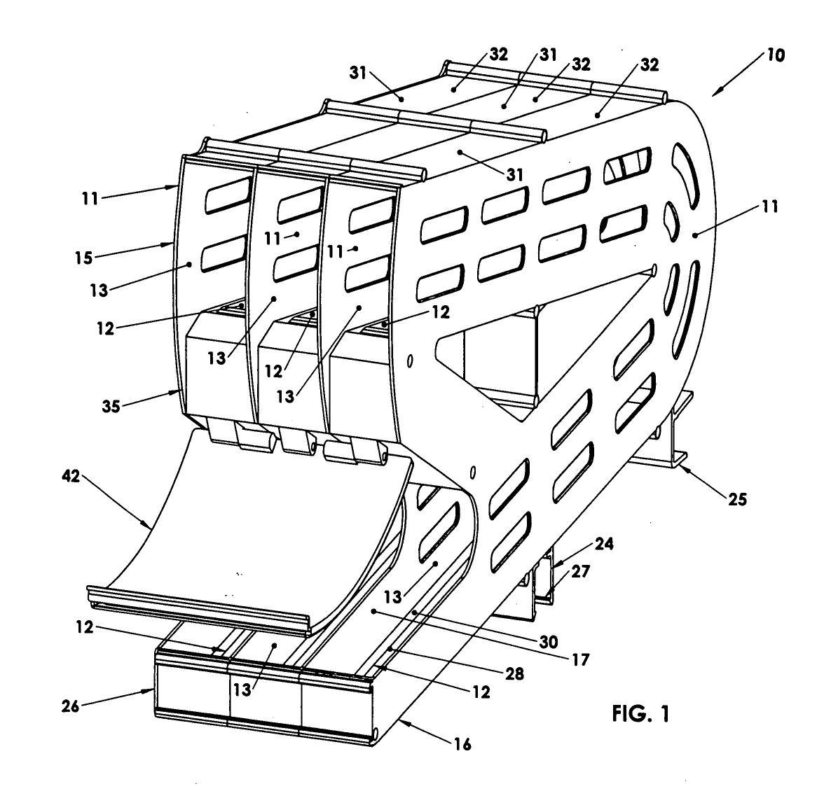

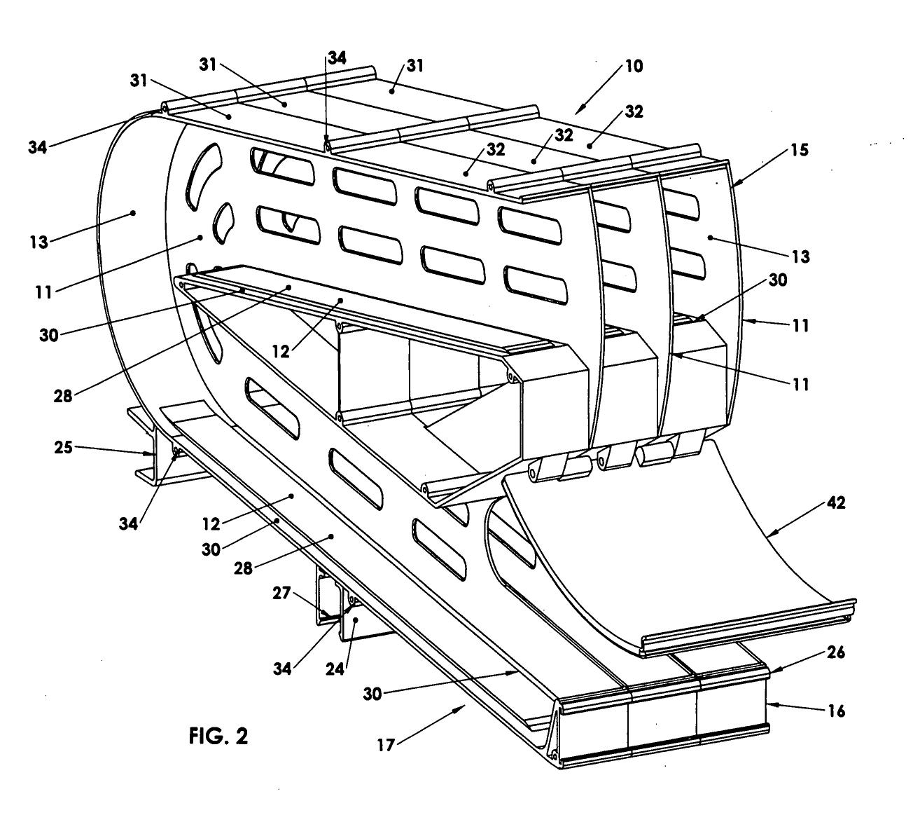

A third embodiment of the present invention is provided in that each vertically disposed panel 11 is provided with a horizontally extending ledge 31 protruding in one direction therefrom for thereby providing the entire of the ramp assembly 12. In other words, each vertically disposed panel 11 is integrally or unitarily molded with a ledge 31 to provide a unitarily molded subassembly 32. Accordingly, in order to assemble a three-chute dispenser 10 as illustrated in FIGS. 1 and 2, three of these molded subassemblies 32 are secured side by side together by any conventional means, such as by snap fit conventions, (here by self tapping screws received in molded screw passages 34) to provide the completed three-chute assembly. In order to close off the vertical face of the last subassembly 32, the last vertically disposed panel 11 in the form of cover panel 35 is secured in place. Accordingly, due to this ability to manufacture the dispensers 10 by the stacking of molded subassemblies, the manufacture thereof is inexpensive and the assembly is extremely easy.

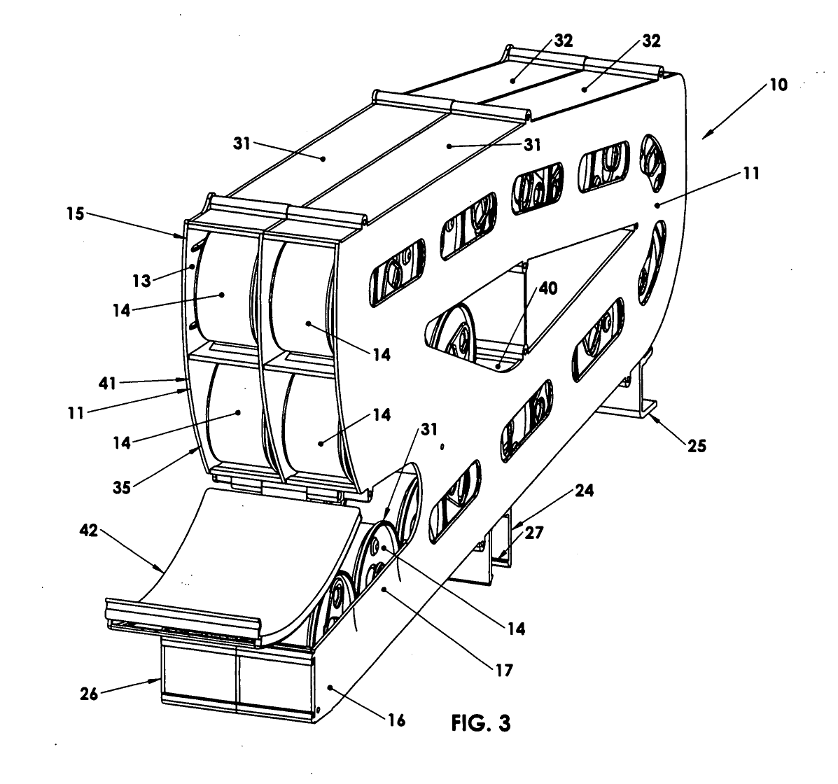

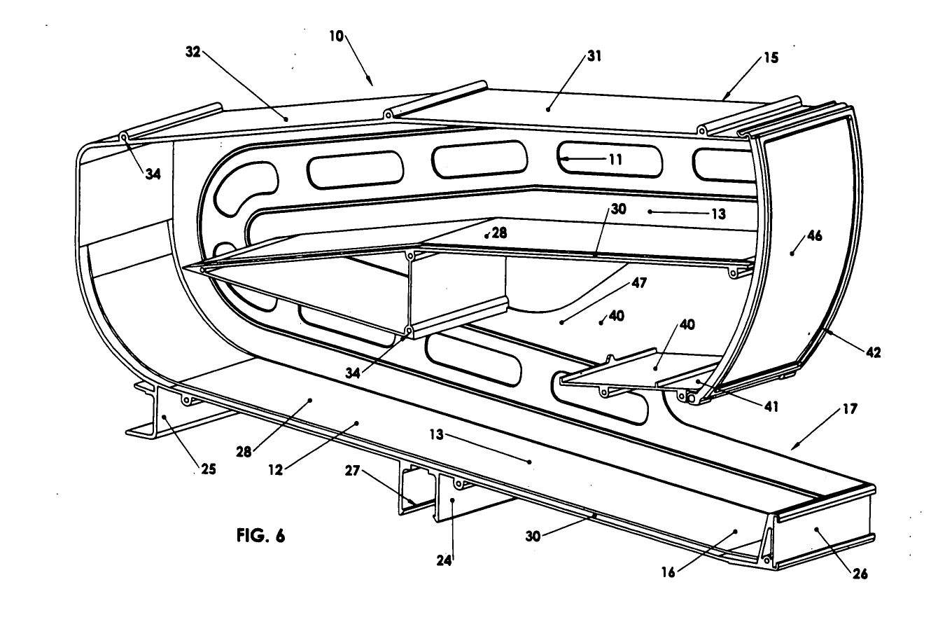

Referring to FIGS. 3 and 6, another feature of the dispenser 10 of the present invention is illustrated which includes a secondary ramp assembly 40 which is also slightly inclined to receive rolling stock 14 at an upper end 41 thereof, and positioned under the upper portion 15 of said chute or chutes 13 but above the lower portion 16 for storing extra articles 14 thereon in the otherwise unused space between the upper and lower portions. Secondary ramp assembly 40 at the bottom end thereof includes a bottom article access 47 for dropping or passing articles 14 from the secondary ramp assembly 40 to the underlying lower portion 16 of chute 13 when no articles 14 remain under the access 47. Accordingly, articles 14 contained within secondary ramp assembly 40 also have access to chute 13 for dispensing access at 17.

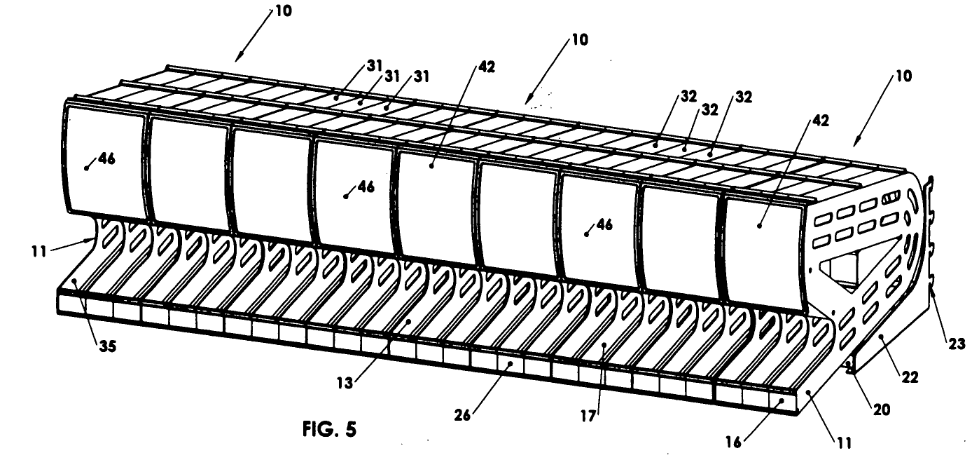

A hinged access door 42 covers the stock of access area 15 in the upper end 41 of secondary ramp assembly 40. When access door 42 is hinged to its closed position, as illustrated for example in FIG. 5, removable exterior advertising display indicia is disposed on the exterior surface 46 of hinged doors 42 for indicating the article 14 contained in the respective chutes 13 for advertising purposes. Note that the contours of the doors 42 may take on different configurations to better distinguish between articles 42 contained within the dispensers 10. For example, the hinged access door 42 in FIG. 3 is convex when closed as illustrated in FIG. 5 and the hinged door 42 in FIG. 4 is concave when closed.

While the present invention as been discussed in relationship to rolling stock in the form of articles 14 which are shown in the forms of cans, it must be remembered that other articles may be used in the same system. For example, plastic or glass bottles.

It can also be readily visualized that when store stock resets are required, that the dispensers 10, with stock articles 14 included, may be easily moved from one bar shelf support system of the present invention to another without having to remove articles 14 from the dispensers, and without having to disassemble the dispensers 10.

We claim:

1. A modular gravity feed storage and dispensing assembly, including a dispenser comprising:
a plurality of spaced vertically disposed panels with a ramp assembly disposed between adjacent vertically disposed panels whereby a chute is provided between each of the adjacent panels for defining a travel path to guide articles traveling therealong between adjacent panels;
said ramp assembly being slightly inclined so as to allow cylindrical articles to be rollingly advanced by means of gravity from an upper portion between said panels in said chute to a lower portion between said panels in said chute;
a removal area disposed proximate said lower portion of said chute for allowing selective removal of one or more of said articles from said dispenser;
a parallel pair of spaced and horizontally disposed elongated shelf bars supported on opposite ends for thereby providing front and rear dispenser support bars;
spaced front and rear support saddles depending downwardly from said dispenser and positioned to respectively register over said front and rear support bars with a front portion of said dispenser containing said removal area overhanging said front dispenser support bar;
said rear support saddle having a rearward facing C-shaped configuration dimensioned and contoured to slide rearwardly over said rear support bar; and
said front support saddle having a downwardly facing C-shaped configuration dimensioned and contoured to slide downwardly over said front support bar after said rear support saddle is slid in position over said rear support bar whereby said dispenser is prevented from sliding or tipping over in the forward direction.

2. The assembly of claim 1, wherein said rear support bar is higher than said front support bar.

3. The assembly of claim 1, said front support saddle having opposed inwardly extending protrusions on distal ends of said front saddle positioned and dimensioned to protrude slightly under said front bar for thereby serving as a removal resistance detention of said front saddle from said front bar.

4. The assembly of claim 1, said ramp assembly having a central raised ramp surface running with said chute for engagement with a rolling article to be dispensed, and side relief channels on opposite sides of said ramp surface to receive annularly protruding end rims of an article rolling down said ramp surface whereby said article will always be in rolling contact with said ramp surface.

5. The assembly of claim 1, a first one of said vertically disposed panels having a ledge horizontally protruding in one direction therefrom for thereby providing the entire of said ramp assembly, and a second of said vertically disposed panels secured to distal edges of said ledge to provide a completed dispenser.

6. The assembly of claim 5, including a second of said first one panel having distal edges of said ledge thereof secured to a side of said first one panel opposite to said one direction for thereby providing a completed dispenser with two of said chutes.

7. A modular gravity feed storage and dispensing assembly, including a dispenser comprising:
a plurality of spaced vertically disposed panels with a ramp assembly disposed between adjacent vertically disposed panels whereby a chute is provided between each of the adjacently panels for defining a travel path to guide articles traveling therealong between adjacent panels;
said ramp assembly being slightly inclined so as to allow cylindrical articles to be rollingly advanced by means of gravity from an upper portion between said panels in said chute to a lower portion between said panels in said chute;
a removal area disposed proximate said lower portion of said chute for allowing selective removal of one or more of said articles from said dispenser;
said ramp assembly having a central raised ramp surface running with said chute for engagement with a rolling article to be dispensed, and side relief channels on opposite sides of said ramp surface to receive annularly protruding end rims of an article rolling down said ramp surface whereby side surfaces of said article will remain in rolling contact with said ramp surface.

8. The assembly of claim 7, a first one of said vertically disposed panels having a ledge horizontally protruding in one direction therefrom for thereby providing said ramp assembly, and a second of said vertically disposed panels secured to distal edges of said ledge to provide a completed dispenser.

9. The assembly of claim 8, including a second of said first one panel having distal edges of said ledge thereof secured to a side of said first one panel opposite to said one direction for thereby providing a completed dispenser with two of said chutes.

10. A modular gravity feed storage and dispensing assembly, including a dispenser comprising:
a plurality of spaced vertically disposed panels with a ramp assembly disposed between adjacent vertically disposed panels whereby a chute is provided between each of the adjacently panels for defining a travel path to guide articles traveling therealong between adjacent panels;
said ramp assembly being slightly inclined so as to allow cylindrical articles to be rollingly advanced by means of gravity from an upper portion between said panels in said chute to a lower portion between said panels in said chute;
a stock access area at the upper end of said upper portion for allowing selective loading of articles into said chute;
a removal area disposed proximate said lower portion of said chute for allowing selective removal of one or more of said articles from said dispenser;
a first one of said vertically disposed panels having a ledge horizontally protruding in one direction therefrom for thereby providing the entire of said ramp assembly, and a second of said vertically disposed panels secured to distal edges of said ledge to provide a completed dispenser.

11. The modular assembly of claim 10, wherein said first one of said vertically disposed panels and said ledge are a unitarily molded subassembly.

12. The modular assembly of claim 10, including a second of said first one panel having distal edges of the ledge thereof secured to a side of said first one panel opposite to said one direction for thereby providing a completed dispenser with two of said chutes.

13. The modular assembly of claim 10, including a secondary ramp assembly which is also slightly inclined to receive rolling stock at an upper end thereof, and positioned under said upper portion but above said lower portion for storing extra articles thereon in the otherwise unused space between said upper and lower portions, said secondary ramp assembly including a bottom article access for passing articles from said secondary ramp assembly to said underlying lower portion of said chute when no articles remain under said access in said lower portion.

14. The modular assembly of claim 13, including a hinged access door covering said stock access area, and said upper end of said secondary ramp assembly and removable exterior advertising display indicia on said door for indicating the article contained in said chute.

15. The modular assembly of claim 10, including a hinged access door covering said stock access area, and removable exterior advertising display indicia on said door for indicating the article contained in said chute.
